(19) United States
(12) Patent Application Publication
(10) Pub. No.: US 2005/0031496 A1
(43) Pub. Date: Feb. 10, 2005

(54) Target plate for mass spectometers and use thereof

(76) Inventors: Thomas Laurell, Lund (SE); Johan Nilsson, Bjarred (SE); Gyorgy Marko-Varga, Malmo (SE)

Correspondence Address: LADAS & PARRY LLP, 224 SOUTH MICHIGAN AVENUE, SUITE 1200, CHICAGO, IL, 60604, US

(21) Appl. No.: 10/498,043

(22) PCT Filed: Dec. 11, 2002
(86) PCT No.: PCT/SE02/02284

(30) Foreign Application Priority Data
Dec. 11, 2001 (SE) 0104125.0
Jul. 15, 2002 (SE) 0202223-4
Aug. 13, 2002 (SE) 0202398-4

(51) Int. Cl. G01N 24/00

(52) U.S. Cl. 422/104; 436/173

(57) ABSTRACT

A plate suitable for use with mass spectrometers comprising a number of target spots arranged in a surface portion of said plate making it possible to deposit small amounts of fluid at said target spots without the fluid escaping or getting mixed with fluid deposited at another target surface of the same plate. The target surfaces being arranged in a surface portion of said plate so that a base material of said plate constitutes the walls of receptacles, characterised in that the shape, size, temperature and possible agents of said receptacle facilitate evaporation of a solution in which sample molecules are suspended. Embodiments include different types of matrix and enzymes arranged at said spots, and methods for enhancing MALDI analysis efficiency.

### FIELD OF INVENTION

The present invention relates to methods and devices for chemical analysis. More specifically it relates to methods and devices for preparation of small amounts of sample molecules, facilitating a subsequent analysis using e.g. matrix-assisted laser desorption/ionisation time-of-flight mass spectrometry (MALDI-TOF MS).

### BACKGROUND

The field of bioanalysis is experiencing an increased need for fast and accurate devices/methods and also for devices/methods that are capable of establishing an accurate and precise analysis in spite of small specimen volumes.

Mass spectrometry involving ionisation by matrix-assisted laser desorption (MALDI) has established itself as a standard procedure for the analysis of biosubstances with large molecules. For this purpose, time-of-flight mass spectrometers (TOF-MS) are usually employed, although Fourier transform ion cyclotron resonance spectrometers (FT-ICR) or quadrupole ion trap mass spectrometers (in short: ion traps) are frequently/routinely used as ionisation principles for protein sequencing.

In the following, the molecules of biosubstances to be studied will be referred to simply as “analyte molecules” or “biomolecules”. In all cases, analyte molecules are present either in very diluted form in aqueous solutions, pure or mixed with organic solvents. Sometimes these analytical solutions are very complex and contaminated with respect to the requirements of the analytical procedures, e.g., in the case of body fluids.

The biosubstances include all biopolymers and sometimes other substances with large molecules. “Biopolymers” comprise oligonucleotides (i.e. fragments of genetic material in various forms such as DNA or RNA), polysaccharides and proteins (the essential building blocks of the living world) as well as their special analogues and conjugates such as glycoproteins or lipoproteins, and peptides arising from the action of digestive enzymes.

The selection of matrix substance for MALDI depends on the type of analyte molecule; more than a hundred different matrix substances are now known. One of the tasks of the matrix substances include to isolate the analyte molecules from each other wherever possible and bind them to the sample carrier plate, to transfer the molecules into the vapour phase by forming a vapour cloud during the laser bombardment, and ultimately to ionise the biomolecules by protonation or deprotonation, i.e., to add or remove one or more protons. For this task it has proven useful to incorporate the analyte molecules individually in the crystals of the matrix substances during their crystallisation, or at least to finely distribute them in the boundary areas between the crystals. Here it seems important to separate the analyte molecules from each other, i.e., no clusters of analyte molecules should be allowed in the prepared matrix crystal sample.

A variety of procedures are known for applying analytes and matrices. The simplest of these entails the pipetting of a solution containing both analyte and matrix onto a cleaned metallic sample support. The drop of solution wets a certain area of the metal surface (or its oxide layer) whose size on hydrophilic surfaces is many times larger than that of the diameter of a drop. The size depends on the hydrophilicity and the microstructuring of the metal surface as well as on the properties of the droplet, in particular that of the solvent. After drying the solution, a sample spot consisting of small matrix crystals and having the same size as that of the originally wetted surface area forms. The matrix crystals are usually not uniformly distributed throughout the formerly wetted area. As a rule, crystals of the matrix start growing at the inner margin of the wetting surface on the metal plate. They then grow towards the interior of the wetting surface. They often form thin needle crystals, as is the case for example for the frequently used matrices 5-dihydroxybenzoic acid (DHB) or 3-hydroxypicolinic acid (HPA), which often stand out from the carrier plate at the interior of the spot. The centre of the spot is frequently empty or covered with fine crystals, although they often cannot be used for MALDI ionisation because of their high concentration of alkaline salts. The loading of the crystals with biomolecules is also very uneven. This type of loading therefore requires viewing the sample carrier surface during MALDI ionisation by a video microscope, which can be found in any commercially available mass spectrometer used for this type of analysis. Ion yield and mass resolution vary in the sample spot from place to place. It is often an arduous process to find a suitable position on the sample spot with a satisfactory analyte ion yield and mass resolution, and only experience, trial and error allow for improvements.

Although there are control programs for mass spectrometers with algorithms for automatically seeking the best spots for MALDI-ionisation, such procedures, involving many attempts and evaluations, are necessarily very slow.

With other loading procedures the matrix substance is already present on the carrier plate before application of the solvent droplets, which now only contain analyte molecules.

If the surface of the sample carrier plate is not hydrophilic, but hydrophobic, smaller crystal conglomerates are formed, and the droplets tend to wander in an uncontrollable manner during drying. Hence the localisation of the crystal conglomerates cannot be predicted and must be sought during the MALDI process. Furthermore, there is a considerable risk that droplets will conglomerate and thus render a separate analysis of samples impossible.

Biosample analyses are now performed in their thousands, a situation which demands automatic high throughput procedures. A visual control or search, or even an automated search, would obstruct such a high throughput procedure.

Recent prior art includes a procedure which leads to local and size-defined crystallisation fields on small hydrophilic anchor regions of 100 to 800 micrometer in diameter within an otherwise hydrophobic surface (DE 197 54 978 C2). The aqueous drops are fixed by the hydrophilic anchors and prevented from wandering even when they initially rest on surrounding lyophobic areas. During drying the droplets withdraw onto the anchor, and relatively dense, homogeneously distributed, crystalline conglomerates arise on the exact position of these anchors (sometimes even structured as a single compact crystalline block depending on the type and concentration of matrix substance). It could be shown that the detection limit for analyte molecules improves with reduction of the surface area of the wetting surface. Thus, smaller quantities of analytes and more diluted solutions can be worked with during sample preparation; such an advantage is expressed in better running biochemical preparatory procedures and reductions in chemical material costs. With a suitable preparation the analytical sensitivity over the surface of the sample is highly uniform. Thus the ionisation process can be freed from the need to perform visual or automated searches for favourable sites; instead a “blind” bombardment of the crystal conglomerates with desorbing laser light can be used. This preparation method for prelocated spots of equal sensitivity accelerates the analytical process.

The crystal conglomerates forming on the hydrophilic anchor surfaces reveal a microcrystalline structure suitable for the MALDI-process. As the speed of the drying process is increased, the crystalline structure becomes finer.

Here a “hydrophobic” surface is understood as a water repellant surface, i.e. one resistant to wetting by aqueous solutions. Correspondingly, a “hydrophilic” surface is understood as one that can be easily wetted by water. “Oleophobic” and “oleophilic” (also referred to sometimes as “lipophobic” and “lipophilic”) refer to surfaces which repel or which can be wetted by oil, respectively. Organic solvents that are not miscible with water usually have an oily nature in this meaning of wettability, i.e. they can wet oleophilic faces. They are as a rule miscible with oil. Organic solvents that are miscible with water, e.g. methanol, acetone or acetonitrile, can wet both oleophilic and hydrophilic surfaces in a pure state. However, the wettability of oleophilic surfaces reduces as the water content increases.

For a long time it has been the opinion that hydrophobic surfaces are always also oleophilic, and that oleophobic surfaces are always hydrophilic. However, for some years it has been known that surfaces exist which are both hydrophobic and oleophobic; these include smooth surfaces of perfluorinated hydrocarbons such as polytetrafluoroethylene (PTFE). Such surfaces are designated here as “lyophobic”, a term which has been adopted from colloidal science.

Recently, it has also become known that the wetting or liquid repelling character of a surface strongly depends on its microstructure. An example of this is the so called “lotus effect” (named after the lotus-plant).

A surface is particularly designated as “hydrophobic” when a drop retracts on a surface during drying or aspiration with a pipette, reducing the wetted surface reduces in size and leaving behind a dry surface (so called “dynamic hydrophobia”).

As a rule, biomolecules are best dissolved in water, sometimes with the addition of organic, water-soluble solvents such as alcohol, acetone or acetonitrile. The analytical solutions of biomolecules sometimes also contain other substances such as glycols, glue-like buffering agents, salts, acids or bases depending on their preparation. The MALDI process is disrupted considerably by the presence of these impurities, sometimes through prevention of protonation, and sometimes through the formation of adducts. In particular, alkali ions often form adducts with analyte molecules of varying size and prevent any precise mass determination. The concentration of alkali ions in the sample preparation, as well as the concentration of other impurity substances must be kept extremely low by careful purification procedures.

For purification and simultaneous enrichment of biomolecules one can use so-called affinity adsorption media similar to those used in affinity chromatography. While in affinity chromatography one uses highly bioselective affinity adsorbents, for the purification of initially unknown mixtures of biopolymers without losses of special types of biomolecules, one needs non-specific adsorbents that can bind all biomolecular constituents of the mixture to as near a similar degree as possible.

For purification of peptides, proteins or DNA mixtures, sponge-like microspheres of adsorbent material (such as POROS, a registered trademark of Applied Biosystems, Inc.), pipette tips filled with sponge-like adsorbent (such as ZIPTIPs, a registered trademark of Millipore Corporation) or C18 coated magnetised spheres (such as GenoPure, a product of Bruker Daltonics, Inc.) have proven particularly useful until now. These materials are all strongly oleophilic and bind peptides or oligonucleotides via hydrophobic bonds. As a rule, biomolecules can be eluted using aqueous methanol or acetonitrile solutions, and elution can often be assisted by altering the pH-value. However, purification with these materials is labour-intensive since it requires additional materials and additional procedural steps.

Affinity capture methods have become known also for biospecific selection of certain biomolecules in connection with mass spectrometric analysis, see e.g., U.S. Pat. Nos. 6,020,208, 6,027,942, or 5,894,063 (T. W. Hutchens and T.-T. Yip). Such biospecific affinity adsorption processes can be likewise used for purification.

In US application 20020045270A1 is disclosed a sample support plate with hydrophilic anchors in a strongly hydrophobic environment suitable for MALDI analysis. The plate provide areas with affinity adsorbents adjacent to the hydrophilic anchors for purifying biosubstances and, optionally, for performing an affinity selection of biosubstances, whereby the finally prepared matrix sample crystals with the biosubstances for the MALDI analysis are adequately localised on the hydrophilic anchors.

In a paper of Ekström et al., (Integrated micro-analytical technology enabling rapid and automated protein identification (Anal. Chem. January 2000)) is presented an integrated micro-analytical system, where amounts of samples are ejected onto a high-density nanovial MALDI-target plate. The so deposited sample is subsequently analysed by MALDI-TOF MS and the resulting peptide map is used for database search.

In a paper by Miliotis et al. (“Rapid Com. Mass Spect. 16, 2002, page 117-126), is described matrix pre-coated nanovial MALDI targets, and in a paper by Ericsson (Ericsson D, Proteomics Vol 1, 2001, pages 1072-1081) is described on-target nanovial digestion of proteins.

### SUMMARY

Generally an object of the present invention is to provide a target plate having spots for use in an array format and being provided with pre-positioned functions. Said plate also being devised to support a two-dimensional read-out algorithm by protein sequencing and/or peptide mass fingerprinting. The target plate is preferably ready-made prior to sample deposition. This means that all necessary reagents and chemicals such as internal standards and crystallisation agents will be targeted on the plate prior to use. The two dimensional approach on the target plate will be made in a way that e.g. 5 different crystallisation agents will be used for the same sample. This will result in that different sequences of the proteins will be detected by the 5 various crystallisation agents, thereby increasing the total sequence coverage of the proteins present in the samples.

Correspondingly and alternatively, embodiments of the invention can comprise an additive dimension were e.g. 5 different enzymes will be deposited. The different enzymes will have varying substrate selectivity. This will ultimately result in a differing cleavage specificity whereby the resulting enzymatic product, the peptide composition will differ. Adding a second dimension of diversity in the array target plate performance, these differing peptides from the enzymatic first dimension of analysis will then be analysed by the array of crystallisation agents. This will ultimately increase the versatility of protein sequences and sequence coverage of the proteins analysed. The present invention satisfies the initially mentioned needs. A target plate and a method for use thereof and also a device for depositing an amount of sample on said plate is provided. The method together with subsequent MALDI-TOF analysis and data base search is devised to give fast and accurate analysis results.

In a preferred embodiment a target plate having a target-plate surface is arranged to receive small, discrete and repeatable amounts of fluid dispensed from a micro dispensing device. Said target-plate surface is provided with a two-dimensional array of target spots. Each spot is provided with a spot agent, such that an amount of fluid received at a spot can interact with said agent. The agent can comprise a matrix solution or alternatively a matrix solution together with one or more digestive enzymes provided to enzymatically cleave analytes.

A dispensing control-unit is arranged to control the dispenser to shoot at the right spot at a controlled pace and dispensing an appropriate amount of fluid for each spot. A temperature control unit is connected to a target plate heater, said heater being provided for giving the target plate an appropriate temperature. When a burst of droplets is shot and subsequently is hitting a target spot, the heat makes the fluid to evaporate, leaving an increased-concentration of analyte molecules together with the agent enhancing the desired interaction between said analyte molecules and agent.

In another preferred embodiment a sample is divided into a number of portions. Each portion is dispensed/shot to a separate spot. Each of the separate spots is provided with a different agent, e.g. different digestive enzymes or different types of matrix. In the case with different matrices, spots are arranged to receive different portions of the same sample. The spots are provided with different matrix solutions having different ionisation energy, such that (slightly) different spectrograms is obtained for the same analyte, i.e., different portions of the same sample, which enables increased specificity for the analysis.

In another embodiment the agents on the spots can be different digestive enzymes. A computer for matching the output from the mass spectrometer is provided with a database for identifying analysts in the sample. Said database is provided with spectrograms for a large number of known substances/parts of substances that has been subjected to different agents prior to mass spectrometry. Said computer is also arranged to present the most plausible match, or matches (if any) to a person having interest in the result of the analysis.

Disposability

Embodiments of the present invention can easy provide disposable target plates because they are expected to be cheap due to low costs of manufacturing by polymer materials. A further advantage of using disposable plates is that both the so-called carry over (contamination stemming from earlier use, not totally removed during wash/clean) and the so-called memory effect is eliminated.

### DRAWINGS

These and other features, aspects and advantages of the present invention will become better understood with reference to the following description, appended claims, and accompanying drawings where

FIG. 1a,b,c and d shows a target plate with details of a nanovial including cross sections.

FIG. 2 shows a flowchart of a method for analysis using a target plate.

FIG. 3 shows a schematically a part of a MALDI-target plate with deposited matrices and enzymes in a specific pattern.

### DESCRIPTION

Definitions

In the context of the present application and invention the following definitions apply:

The term “annotate” is intended to mean the act of deciding that a spectrum of a MALDI spot corresponds to a certain biopolymer

The term “biopolymers” is intended to designate a group of substances comprising, but not limited to, proteins, nucleic acids, and polysaccharides.

The term “sample crystal” is intended to mean the dry result of chemical and physical reactions concerning matrix and sample on the MALDI-Spot.

The term “MALDI Spot” is intended to mean an area at the MALDI target plate for receiving and holding samples/sample crystals.

The term “matrix” is intended to mean a substance applied on the MALDI-spots prior to or at the same time or after the samples are applied and which substance facilitates different aspects of the analysis of the sample molecules, e.g., adherence to plate, distribution in space, absorption of laser energy.

The term “spectral data” is intended to mean data for a sample crystal comprising the relative intensity and the mass/charge quotient for the ions measured with a MALDI instrument during laser desorption/ionisation of said spot. Spectral data for a protein comprises the corresponding data resulting from an identical MALDI analysis of a spot containing only that protein in pure form. The present invention is directed towards a target plate for preparing analyte samples for matrix-assisted laser desorption/ionisation time-of-flight mass spectrometry (MALDI-TOF MS). Alternative terms: spectrum, fingerprint.

The term “nanovial” is intended to mean small vials, in this context preferably on a MALDI-plate, and preferably comprising a MALDI-spot. Alternative terms: vial, well, spot

Target Plate

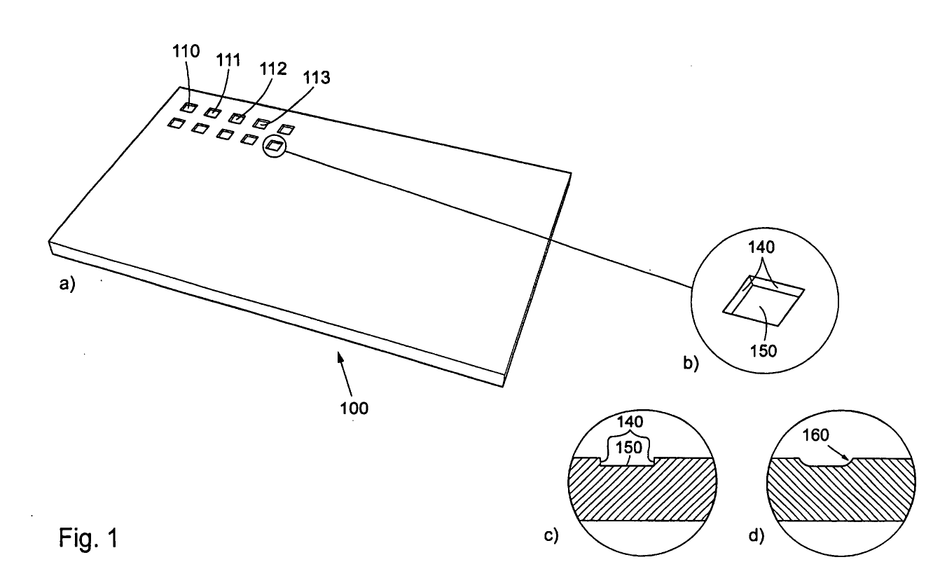

A preferred embodiment of the invention is shown in FIG. 1. A target plate 100 is provided with a number of nanovials 110, 111, 112 etc regularly arranged at said plate. Each vial 110, 111 etc is provided with walls 140, and a bottom surface, or spot 150. Alternative embodiments include vials 160 of other shapes e.g. round, rounded, with slanting or elliptically shaped walls, and having a depth of no more than 100 micrometers, preferably not more than 50 micrometers thereby matching the properties of MALDI laser beams in use today. Deeper vials could affect MALDI-TOF mass resolution negatively.

Size and Arrangement of Spots

In an advantageous embodiment said walls are arranged to have a width of 300 micrometer and a height of less than or equal to 50 micrometer, providing the vial with a maximum depth of 50 micrometer and giving the spot 150 an area of approximately 300 times 300 micrometer. This area is arranged to match with the effective cross-section area of laser beams of commercially available MALDI lasers, such that the area of the spot is approximately within the range of 25 to 400 percent of laser beam cross-section area.

The spots are preferably arranged as a two-dimensional array with a distance between spots centre to centre so adapted as to coincide with corresponding measures of commercially available high-density plates used in MALDI spectrometry. These centre to centre distances is also preferably such that centre to centre distances of dispenser nozzles of an array dispenser or a dispenser array are made to correspond.

Plane Target Plate without Vials

An alternative preferred embodiment comprises a substantially plane plate having no vials or recesses of any kind, instead the plate is provided with reference points which can comprise the corners and/or edges to facilitate proper application, processing and measurements of the molecules in correct areas of the plate. Analytes and/or other substances/fluids are kept in the right spot by means of surface tension and/or surface modified surfaces such that two nearby amounts of fluid on two nearby spots do not mix even if the distance is 800 micrometers centre to centre.

Method of Providing the Plate Spots with Agents

Commercially available methods for providing the plate spots with agent can be used. In an alternative embodiment a micro dispenser is used to dispense, i.e. shoot small droplets of agent towards the target plate, thereby providing it with the desired agent or pattern of agents

Use of Plate

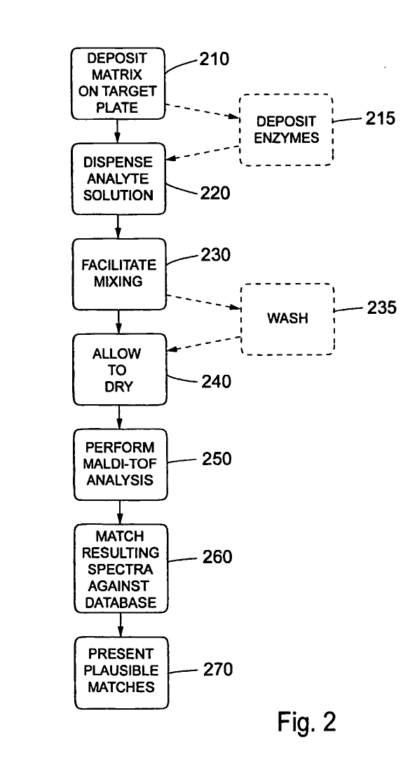

Referring to FIG. 2, an embodiment of a method of using the target plate 100 for analysis of samples comprises the following steps:
Loading 210 the target plate spots 150 with one or preferably with a pattern of different MALDI-matrix solutions, i.e. depositing a thin layer of matrix on each spot. The MALDI-matrix solution is arranged to i) absorb energy and protect the analyte from excessive energy during laser bombardment, i.e. to prevent analyte decomposition. It is also arranged to ii) enhance ion formation of the analyte by photoexcitation or photoionisation of matrix molecules followed by proton transfer to the analyte molecule and iii) said matrix is also arranged to dilute sample into the matrix thereby preventing association of analyte molecules.
(optional step) Loading 215 the target plate spots with none, one or preferably with a pattern of different digestive enzymes.
Dispensing 220 analyte solutions on said loaded target plate spots.
Facilitating 230 mixing of analyte and matrix or matrix/enzyme solutions in each spot. (This will happen spontaneously at room temperature when using droplet dispensing and increased mixing speed is obtained in the arranged micro format.)
Allowing 240 said mixture to dry/solution to evaporate, forming crystalline coating on each spot of the target plate.
Subjecting 250 the target plate to MALDI-TOF MS analysis subsequently resulting in intensity versus m/z graphs, i.e. in mass spectrograms, for each spot on the plate (m=mass, z=charge, for ions of the analyte)
Matching 260 each spectrum against a database of known spectra.
Presenting 270 plausible matches

Preferably, the steps of dispensing 220, facilitating 230 and allowing to dry/solution to evaporate 240 is devised such that a first volume of a protein containing substrate/solution, giving rise to a first concentration of proteins and, by the presence of enzymes, a concentration of peptides, gives rise, because of the evaporation of solution/fluid, to a second concentration of proteins more favourable for enzymatic cleavage than the first, cf. Michaelis-Menten equation of enzyme kinetics.

The dispensing 220 is preferably performed using a micro dispenser having one or preferably a multitude of dispenser nozzles, making it possible to dispense amounts of the same or different samples at the same time, i.e., in parallel.

The action of the dispenser is controlled by a control unit that synchronises the action with the flow of analyte. The stepwise movement of the target plate for a next row of spots to be placed in front of (under) the dispenser nozzles is also synchronised with the actions of the dispenser.

The dispensing of droplets is conducted in symphony with the evaporation of the eluant so that the amount of analyte e.g. proteins, deposited on the spot can be increased over time by dispensing more droplets on the same spot. The evaporation is devised to take place in a temperature and in a so small volume that it becomes rapid, i.e. the most of the deposited solution is evaporated within a few seconds.

In a preferred embodiment the spots are provided with enzymes that, due to the small dimensions, the controlled temperature and the high concentration of proteins, digest said proteins and form a high concentration of peptides. A high concentration of peptide is favourable when performing a further chemical analysis by means of e.g. mass spectrometry.

In this context it is possible to use the device to perform both global expression studies and focussed expression studies.

Activated Biofunctional Surfaces

In the case of activated biofunctional surfaces an additional washing step 235 prior to MALDI analysis is performed.

Surface Modification of Target Plate Vials

In a preferred embodiment of the plate the vials/spots are modified using one or more methods coming from the group comprising hydrophilic chemical modification, hydrophobic chemical modification, metalaffinity coated chemical modification, antibody biochemical modification, antigen biochemical modification, peptide biochemical modification, capturing biomacromolecule modification.

Material

The device is preferably manufactured in silicon, glass or in a polymer material. Silicon is essentially inert when dealing with protein mixtures at room or near room temperature. The material is also very suitable for micro-machining techniques, e.g. for etching away parts of the material with established etching techniques.

Another advantage is that with said etching techniques the dimension measures becomes very precise and it is possible to etch surface with far better than micrometer precision.

The device can optionally be coated with gold or another high conductivity material in order to lead away charges. Alternatively one or more conductive polymers can be used.

Method(s) for Improved Analysis Using Plate, MALDI Apparatus, and Corresponding spectral Databases and Search Algorithms

The spots with enriched analyte molecules arranged in an array format on the target plate will be analysed in the MALDI mass spectrometer using a single dimensional run (simple array format) which means that an array of chemical agents (matrices, enzymes) are screened.

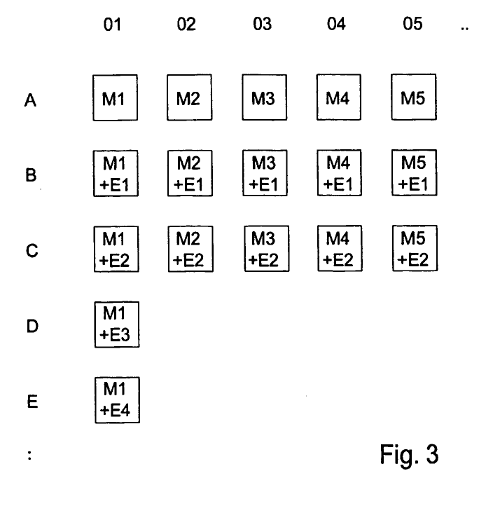

Referring to FIG. 3, the sample positioning in the MALDI instrument will run from position A01, A02 and so on. A real time data base search is performed simultaneously with the ongoing analysis, where the identity of the protein is queried for by comparing the resulting spectrum, said spectrum comprises the relative intensity and the mass/charge for the incorporated peptides. Automatic retrieval of the peptide sequences comprising the proteins is accomplished by searching a database, also called map, that has been compiled in advance.

Real-time identifications are also performed from position A01 where the spot is analysed for possible multi proteins present in the MALDI spot. Such real-time identifications are made by subtracting the peptide masses/spectral data that belongs to the protein that was identified as a significant hit, and perform a second pass search where ongoing ionisation in real-time is made by laser pulsing onto position A01 where additional peptides are ionised from the sample crystal spot. If a second protein identity is confirmed a third pass search is made by the instrument on the very same spot position, A01 subtracting the peptide masses/spectra corresponding to both the first and second protein. After querying the third pass in real-time, additional data base searches are not performed by the instrument on the given target plate in the automated run in this so-called real-time MALDI-target protein screening cascade.

Moving from sample 1 to sample 2 on the target plate; Once the annotation can be confirmed as a high and statistically significant score, the annotation of that protein sample is confirmed in real-time and the instrument switches over to analyse position (spot) A02 on the MALDI sample plate.

Initially all samples are processed in the first dimension (“left to right”, A01, A02, A03 etc) screening through different chemical agents (matrices) in order to generate a multitude of protein crystallisation processes whereby the crystals will have varying physical-chemical properties that will give them different ionisation characteristics whereby the specific peptides present in the sample will find their optimal ionisation and time-of-flight properties.

In case of low levels of protein sample present, the second dimension of the array (extended array format) will be initiated where different enzymes have been used to digest the named protein sample. This means that sample position B01 will be analysed followed by B02 etc. that will hold the first chemical agent (B01), the second (B02) and so on. The same automated run screening through the target plate with the pre-positioned protein sample spots and performing real-time data base searches on all the peptide masses generated by the MALDI instrument will subsequently be performed until statistically significant protein(s) can be identified.

An automated feedback loop function in the processing will halt the screening in the array once the fulfilment of protein sequence given has been obtained. The requirement for protein sequence will be determined by the operator of the study.

The array dispenser will be operated in a number of functions together with the target plate;
Static mode Sample array mapping
Separation mode of array mapping

In the Static mode a single sample will be fed into all the nozzles of the array, thereby dispensing a subset of the same sample onto both the first (chemical agent matrix), and the second dimension different enzymes of the target plate array.

In the Separation mode, new proteins will be deposited onto the target plate in the two dimensions with time.

Dispensing sample droplets can be accomplished with a dispenser array or with an array of dispensers such that simultaneous array deposition provides reduced experimental variation in-between sample spots.

1. A plate suitable for use with mass spectrometers comprising a number of vials and/or target spots arranged in a surface portion of said plate making it possible to deposit small amounts of fluid at said target spots without the fluid escaping or getting mixed with fluid deposited at another target surface of the same plate wherein one or more agents are arranged on said each target spot, said one or more agents are a matrix, an enzyme or a highly selective biomacromolecule affinity binder or a mixture thereof, in such a way that different target spots comprises different agent mixtures, said mixtures comprising different matrices and/or different enzymes with varying substrate selectivity, resulting in a differing cleavage specificity such that a subsequent analysis with MALDI of the enzymatic product, can make use of the information arising from the resulting slightly different spectra.

2. A plate as recited in claim 1, wherein said agents comprise digestion enzymes, such that, because of small dimensions, controlled temperature and sufficiently high concentration of applied protein samples after the equilibrium of the enzymatic reaction the resulting sample will contain a high concentration of peptides.

3. A plate as recited in claim 2, said target surfaces being arranged in a surface portion of said plate so that a base material of said plate constitutes the walls of receptacles, wherein the shape, size and temperature of said receptacle facilitate evaporation of a solution in which sample molecules are suspended.

4. A plate as recited in claim 3, wherein a diameter of the spot is approximately between 300 to 400 micrometers such that it matches the diameter of MALDI laser beams in a relationship of approximately 3 to 1, ranging to 4 to 1.

5. A plate as recited in claim 4, where said shape and size conform to the following limitations:
when viewed from above said receptacle is rectangular in shape;
the spot comprises the shape of a rectangular parallelepiped.

6. A plate as recited in claim 5, where said shape of receptacle comprises a rounded cross section profile.

7. A plate as recited in claim 6, wherein said plate comprises target means making it especially suitable for receiving sample droplets dispensed from a dispenser.

8. A plate as recited in claim 7, wherein said dispenser is a dispenser array or an array dispenser, such that simultaneous array deposition provides reduced experimental variation in between sample spots.

9. A plate as recited in claim 8, wherein said plate comprises target spots arranged in columns and rows and in that the target spots in a column each is provided with the same matrix, and that the target spots in a different column are provided with a different matrix.

10. A plate as recited in claim 9, wherein said plate comprises target spots arranged in columns and rows and in that the target spots in a row each is provided with the same enzyme, and in that the target spots in a different row are provided with a different enzyme, such that, in general, no target spot is provided with the same matrix-enzyme mixture.

11. A plate as recited in claim 10, wherein said plate is devised to be disposable.

12. A method for preparing a plate for subsequent MALDI-analysis, comprising the steps of:
arranging, by dispensing, matrices in target spots, such that the target spots in a column each is provided with the same matrix, and that the target spots in a different column are provided with a different matrix,
application of a first volume of a protein containing substrate/solution on one of said spots,
evaporation of said solution and
enzymatic cleavage, such that said application gives rise to a first concentration of proteins and, by the presence of enzymes, a concentration of peptides, giving rise to, because of the rapid evaporation of solution/fluid, a second concentration of proteins more favourable for enzymatic cleavage than the first.

14. The method according to claim 12 further comprising the step of arranging, by dispensing, enzymes in target spots such that the target spots in a row each is provided with the same enzyme, and in that the target spots in a different row are provided with a different enzyme such that, in general, no target spot is provided with the same matrix-enzyme mixture.

15. The method according to claim 13 for applying a mixture of agent and analyse on a target plate spot comprising that the analyte is applied first.

15. The method according to claim 14 for applying a mixture of agent and analyte on a target plate spot comprising that the agent is applied first.

16. The method according to claim 15 for applying a mixture of agent and analyte on a target plate spot comprising that the agent and analyte is applied simultaneously.
